(19) United States
(12) Patent Application Publication
(10) Pub. No.: US 2024/0008149 A1
(43) Pub. Date: Jan. 4, 2024

(54) HEATING COOKING APPARATUS

(71) Applicant: SHARP KABUSHIKI KAISHA, Sakai City, Osaka (JP)

(72) Inventors: Nobuo TAKEMOTO, Sakai City, Osaka (JP); YU SHINOHARA, Sakai City, Osaka (JP); SHINJI ASAMI, Sakai City, Osaka (JP)

(21) Appl. No.: 18/037,551

(22) PCT Filed: Nov. 24, 2021
(86) PCT No.: PCT/JP2021/042979

§ 371 Date: May 17, 2023

(30) Foreign Application Priority Data
Nov. 26, 2020 (JP) 2020-196079

(51) Int. Cl. H05B 6/64

(52) U.S. Cl. CPC H05B 6/642

(57) ABSTRACT

A heating cooking apparatus includes a heating cooking chamber and a duct member (30). The heating cooking chamber accommodates an object to be heated. The duct member (30) is disposed outside the heating cooking chamber. The heating cooking chamber includes an air intake hole portion that causes the inside and the outside of the heating cooking chamber to be communicated with each other. The duct member (30) includes a main body portion (31) that guides air so that the air travels from a first direction (D1) to a second direction (D2) intersecting the first direction (D1), a suction port (32) through which the air is sucked into the main body portion (31), a blow-out port (33) from which the air is blown out toward the air intake hole portion, and a rectifying portion (35) that determines at least one of a blow-out direction or an airflow distribution of the air at the blow-out port (33) and guides the air to the air intake hole portion.

### TECHNICAL FIELD

The present invention relates to a heating cooking apparatus.

### BACKGROUND ART

A heating cooking apparatus including a heating cooking chamber and a pull-out body is known. The pull-out body is integrated with an opening/closing door. The pull-out body is disposed such that the pull-out body can be pulled out from the heating cooking chamber. Such a heating cooking apparatus as described above is built into a cabinet of a built-in kitchen.

PTL 1 discloses a heating cooking apparatus. Heating functions of the heating cooking apparatus disclosed in PTL 1 include a microwave heating function and a high-speed hot air heating function. The microwave heating function is a function of irradiating an object to be heated with microwaves. The high-speed hot air heating function is a function of blowing out hot air at high speed toward an object to be heated.

### CITATION LIST

### Patent Literature

PTL 1: JP 2010-133634 A

### SUMMARY OF INVENTION

### Technical Problem

However, with the heating cooking apparatus disclosed in PTL 1, there is a risk that the temperature outside the heating cooking chamber may rise. In particular, there is a risk that the temperature of components such as a microwave supply unit may rise. Therefore, the components are cooled by air that is circulated outside the heating cooking chamber. On the other hand, there is also a heating cooking apparatus in which air inside the heating cooking chamber is exchanged with air outside the heating cooking chamber in order to adjust the temperature inside the heating cooking chamber.

In light of the problem described above, an object of the present invention is to provide a heating cooking apparatus that can efficiently utilize air that cools components.

### Solution to Problem

According to an aspect of the present invention, a heating cooking apparatus includes a heating cooking chamber and a duct member. An object to be heated is accommodated in the heating cooking chamber. The duct member is disposed outside the heating cooking chamber. The heating cooking chamber includes an air intake hole portion configured to cause an inside and an outside of the heating cooking chamber to be communicated with each other. The duct member includes a main body portion configured to guide air to cause the air to travel in a first direction to a second direction intersecting the first direction, a suction port through which the air is sucked into the main body portion, a blow-out port from which the air is blown out toward the air intake hole portion, and a rectifying portion configured to determine at least one of a blow-out direction or an airflow distribution of the air at the blow-out port, and to guide the air to the air intake hole portion.

### Advantageous Effects of Invention

According to a heating cooking apparatus of the present invention, air that cools components can be efficiently utilized.

### BRIEF DESCRIPTION OF DRAWINGS

FIG. 1 is a perspective view illustrating a pull-out type heating cooking apparatus according to an embodiment of the present invention.

FIG. 2 is a right side surface view illustrating the pull-out type heating cooking apparatus according to the present embodiment.

FIG. 3 is a top view illustrating the pull-out type heating cooking apparatus according to the present embodiment.

FIG. 4 is a cross sectional view of a heating chamber taken along a plane orthogonal to a third direction in the pull-out type heating cooking apparatus according to the present embodiment.

FIG. 5 is a cross sectional view of the heating chamber taken along a plane orthogonal to a first direction in the pull-out type heating cooking apparatus according to the present embodiment.

FIG. 6 is a front view of the pull-out type heating cooking apparatus according to the present embodiment.

FIG. 7 is a front view of the pull-out type heating cooking apparatus according to the present embodiment.

FIG. 8A is a right side surface view illustrating the pull-out type heating cooking apparatus according to the present embodiment when an air intake duct, to which an air intake damper is attached, is attached.

FIG. 8B is a right side surface view illustrating the pull-out type heating cooking apparatus according to the present embodiment when the air intake duct, to which the air intake damper is attached, is removed.

FIG. 9A is an enlarged cross sectional view of the pull-out type heating cooking apparatus taken along a section line IX in FIG. 8A. (State where the air intake damper causes an air intake hole portion to be open)

FIG. 9B is an enlarged cross sectional view of the pull-out type heating cooking apparatus taken along the section line IX in FIG. 8A. (State where the air intake damper causes the air intake hole portion to be closed)

FIG. 10 is a perspective view illustrating a duct member according to the present embodiment.

FIG. 11 is a right side surface view illustrating the duct member according to the present embodiment.

FIG. 12 is a left side surface view illustrating the duct member according to the present embodiment.

FIG. 13 is a block diagram illustrating a configuration of the pull-out type heating cooking apparatus according to the present embodiment.

FIG. 14 is a perspective view illustrating a cabinet to which the pull-out type heating cooking apparatus according to the present embodiment is attached.

### DESCRIPTION OF EMBODIMENTS

Hereinafter, embodiments of a pull-out type heating cooking apparatus according to the present invention will be described with reference to the drawings. Note that, in the drawings, the same or equivalent components are denoted by the same reference numerals and signs, and description thereof will not be repeated.

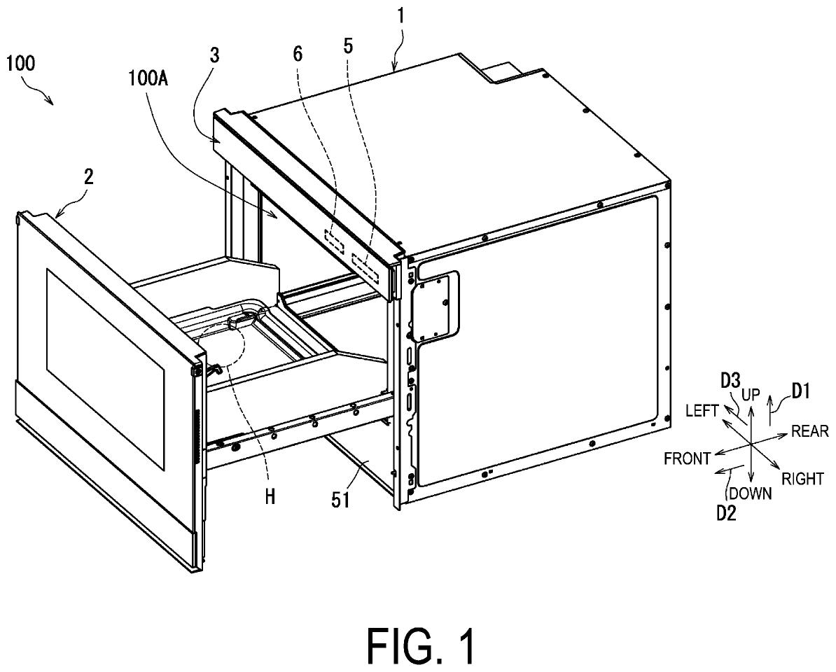

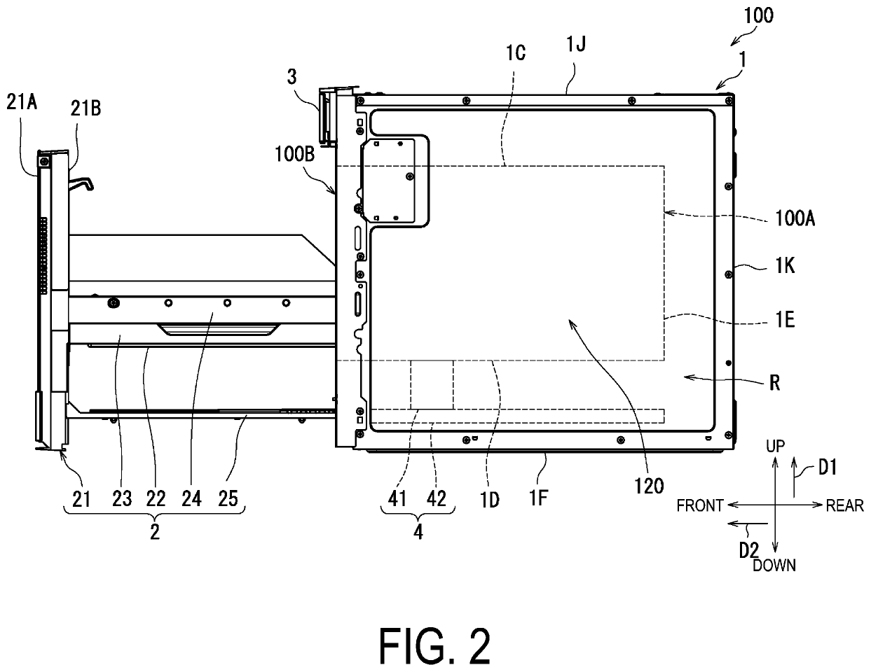

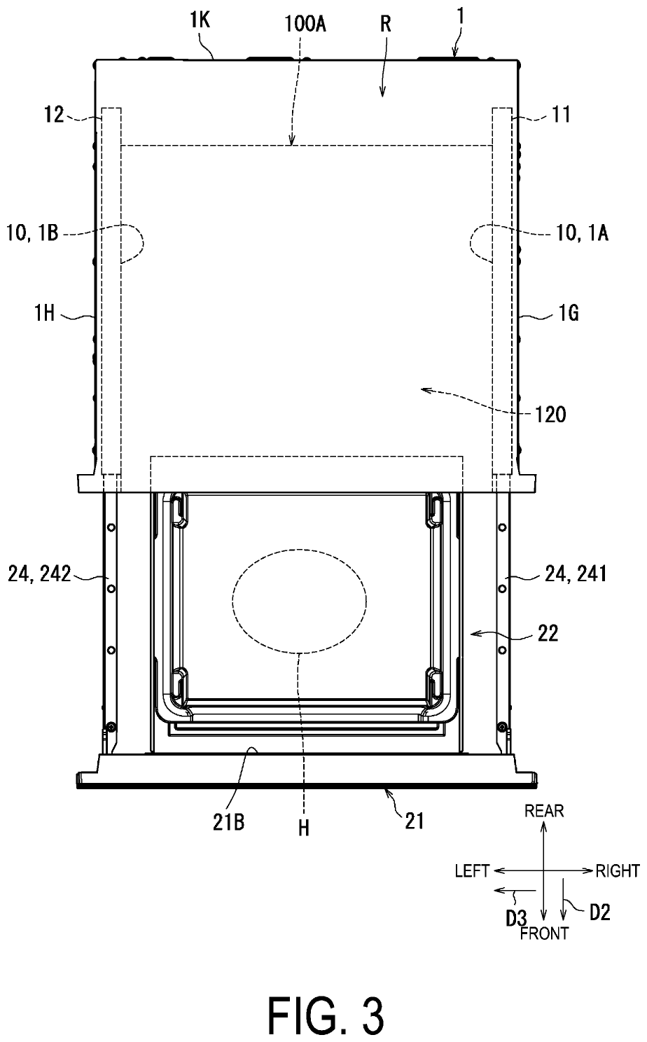

A pull-out type heating cooking apparatus 100 according to the present embodiment will be described with reference to FIG. 1 to FIG. 3. FIG. 1 is a perspective view illustrating the pull-out type heating cooking apparatus 100. FIG. 2 is a right side surface view illustrating the pull-out type heating cooking apparatus 100. FIG. 3 is a top view illustrating the pull-out type heating cooking apparatus 100. More specifically, FIG. 1 to FIG. 3 illustrate the pull-out type heating cooking apparatus 100 in a state where a pull-out body 2 is pulled out. Further, FIG. 1 illustrates an external appearance of the pull-out type heating cooking apparatus 100 as viewed diagonally from the upper front right. The pull-out type heating cooking apparatus 100 is an example of a heating cooking apparatus.

As illustrated in FIG. 1, the pull-out type heating cooking apparatus 100 heats and cooks an object H to be heated. The object H to be heated is, for example, a food product. The pull-out type heating cooking apparatus 100 includes a heating chamber 1, the pull-out body 2, an operation panel 3, a panel 51, a control unit 5, and a storage unit 6.

In the present embodiment, a side at which the operation panel 3 of the pull-out type heating cooking apparatus 100 is disposed is defined as a front side of the pull-out type heating cooking apparatus 100, and a side opposite to the front side (rear face side) is defined as a rear side of the pull-out type heating cooking apparatus 100. Further, a right side when the pull-out type heating cooking apparatus 100 is viewed from the front side is defined as a right side of the pull-out type heating cooking apparatus 100, and a side opposite to the right side is defined as a left side of the pull-out type heating cooking apparatus 100. Further, in a direction orthogonal to a front-rear direction and a right-left direction of the pull-out type heating cooking apparatus 100, a side at which the operation panel 3 is disposed is defined as an upper side of the pull-out type heating cooking apparatus 100, and a side opposite to the upper side (bottom side) is defined as a lower side of the pull-out type heating cooking apparatus 100. Note that these orientations do not limit an orientation of the pull-out type heating cooking apparatus 100 according to the present invention in use. In the present embodiment, a first direction D1 is the upward direction.

As illustrated in FIG. 1 to FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. Then, the heating chamber 1 further includes a heating cooking chamber 100A. The heating cooking chamber 100A is positioned inside the heating chamber 1.

The pull-out body 2 can be pulled out from the heating cooking chamber 100A. Specifically, the pull-out body 2 can be pulled out from the heating cooking chamber 100A along a second direction D2. The second direction D2 intersects the first direction D1. In the present embodiment, the second direction D2 is orthogonal to the first direction D1. The second direction D2 is the forward direction.

The heating cooking chamber 100A includes a placing space 120 that accommodates the object H to be heated. The shape of the heating cooking chamber 100A is, for example, a substantially rectangular parallelepiped shape. The front side of the heating cooking chamber 100A is opened for inserting and removing the object H to be heated. Specifically, the heating cooking chamber 100A includes a pair of side wall portions 10, a back wall 1E, and an opening portion 100B. The pair of side wall portions face each other in a third direction D3. The third direction D3 is the leftward direction. Specifically, the pair of side wall portions 10 includes a right wall 1A and a left wall 1B. The back wall 1E, the right wall 1A, and the left wall 1B are examples of “a plurality of side walls”. The right wall 1A corresponds to an example of a “predetermined side wall”. The back wall 1E intersects the second direction D2. The opening portion 100B faces the back wall 1E. The opening portion 100B communicates with the outside of the heating cooking chamber 100A. The heating cooking chamber 100A further includes a top wall 1C and a bottom wall 1D. Materials of the right wall 1A, the left wall 1B, the top wall 1C, the bottom wall 1D, and the back wall 1E are, for example, a metal.

The heating chamber 1 further includes a space R between the heating chamber 1 and the heating cooking chamber 100A. Specifically, the heating chamber 1 further includes the space R between the bottom wall 1D and the bottom outer wall 1F. The heating chamber 1 further includes the space R between the right wall 1A and the right outer wall 1G. The heating chamber 1 further includes the space R between the left wall 1B and the left outer wall 1H. The heating chamber 1 further includes the space R between the top wall 1C and the top outer wall 1J. The heating chamber 1 further includes the space R between the back wall 1E and the back outer wall 1K.

Once again, as illustrated in FIG. 1, the panel 51 is a plate-like member having a rectangular ring shape. The panel 51 is disposed at the outer periphery of the opening portion 100B, inside the heating chamber 1.

The operation panel 3 includes an operation unit and a display unit. The operation unit receives an operation from a user. The operation unit includes various types of keys. The display unit displays various pieces of information. The display unit includes a liquid crystal panel. The operation panel 3 is positioned at an upper portion of a front surface of the heating chamber 1.

The storage unit 6 is constituted by a Random Access Memory (RAM) and a Read Only Memory (ROM). The storage unit 6 stores a control program for controlling an operation of each unit of the pull-out type heating cooking apparatus 100. The storage unit 6 stores setting information input when the operation panel 3 is operated.

The control unit 5 is a hardware circuit that includes a processor such as a Central Processing Unit (CPU). The control unit 5 executes the control program stored in the storage unit 6.

The pull-out body 2 can be pulled out from and can be retracted into the heating chamber 1. Specifically, the pull-out body 2 includes a lid portion 21, a placing portion 22, and a support portion 23.

Once again, as illustrated in FIG. 2 and FIG. 3, the lid portion 21 can cause the opening portion 100B on the front side of the heating cooking chamber 100A to be open and closed. The lid portion 21 is a substantially rectangular plate-like member. The lid portion 21 includes a front face 21A and a rear surface 21B. The lid portion 21 causes the opening portion 100B on the front side of the heating cooking chamber 100A to be open in a state where the pull-out body 2 is pulled out from the heating cooking chamber 100A. The lid portion 21 can close the opening portion 100B on the front side of the heating cooking chamber 100A in a state where the pull-out body 2 is retracted into the heating cooking chamber 100A.

The object H to be heated can be placed on the placing portion 22. Specifically, the placing portion 22 has a placing surface 22A on which the object H to be heated is placed. The material of the placing portion 22 is a non-metal, and is preferably ceramic or glass, for example. As a result, the placing portion 22 transmits microwaves.

The support portion 23 is fixed to the rear surface 21B of the lid portion 21 and supports a peripheral edge portion of the placing portion 22 such that the placing portion 22 is held in a horizontal state. The material of the support portion 23 is, for example, a metal.

Then, the placing portion 22 and the support portion 23 are pulled out from the inside of the heating cooking chamber 100A to the outside by the pull-out body 2 being pulled out. The placing portion 22 and the support portion 23 are accommodated in the heating cooking chamber 100A in a state where the pull-out body 2 is retracted.

The pull-out body 2 further includes a pair of slide members 24 and a support member 25. The pair of slide members 24 extend in the front-rear direction and define the movement direction of the pull-out body 2. The pair of slide members 24 are fixed to the rear surface 21B of the lid portion 21. Specifically, one slide member of the pair of slide members 24 includes a right side slide member 241, and the other slide member of the pair of slide members 24 includes a left side slide member 242. Each of the right side slide member 241 and the left side slide member 242 is, for example, a member having the front-rear direction as a longitudinal direction. The right slide member 241 and the left slide member 242 face each other in the right-left direction. One end portion of the right slide member 241 is attached to a right edge portion of the rear surface 21B of the lid portion 21. One end portion of the left slide member 242 is attached to a left edge portion of the rear surface 21B of the lid portion 21.

Note that, the heating chamber 1 further includes a right side slide rail 11 and a left side slide rail 12. The right side slide rail 11 is fixed on the right wall 1A in the space R between the right wall 1A and the right outer wall 1G. The left side slide rail 12 is fixed on the left wall 1A in the space R between the left wall 1B and the left outer wall 1H. Each of the right side slide rail 11 and the left side slide rail 12 is a member having the front-rear direction as a longitudinal direction. The right side slide member 241 is supported slidably along the right side slide rail 11. The left side slide member 242 is supported slidably along the left side slide rail 12.

The support member 25 supports the lid portion 21. More specifically, the support member 25 extends in the direction opposite to the second direction D2, and defines the movement direction of the pull-out body 2. One end portion of the support member 25 is attached at a center portion in the right-left direction of the rear surface 21B of the lid portion 21 and below the placing portion 22. The support member 25 is, for example, a plate-like member having the front-rear direction as a longitudinal direction. The support member 25 includes a rack portion. The rack portion includes a plurality of teeth. The support member 25 may be a single plate-like member or a plurality of plate-like members.

Meanwhile, the heating chamber 1 further includes a drive mechanism 4. The drive mechanism 4 drives the support member 25. Then, the drive mechanism 4 is positioned below the heating cooking chamber 100A. Specifically, the drive mechanism 4 is accommodated in the space R between the bottom wall 1D and the bottom outer wall 1F. For example, the drive mechanism 4 includes a drive motor 41, a pinion, and a drive rail 42. The drive rail 42 is fixed in the space R between the bottom wall 1D and the bottom outer wall 1F. The drive rail 42 is a member having the front-rear direction as a longitudinal direction. The support member 25 is supported slidably along the drive rail 42. The pinion is attached to a tip end portion of the drive motor 41. The pinion engages with the rack portion of the support member 25. Furthermore, the support member 25 moves in the front-rear direction as a result of rotation of the pinion. Note that the drive mechanism 4 may drive at least one of the support member 25, the right side slide member 241, and the left side slide member 242. Further, in a case where the right side slide member 241 and the left side slide member 242 are driven, the drive mechanism 4 may be positioned on the side of the heating cooking chamber 100A.

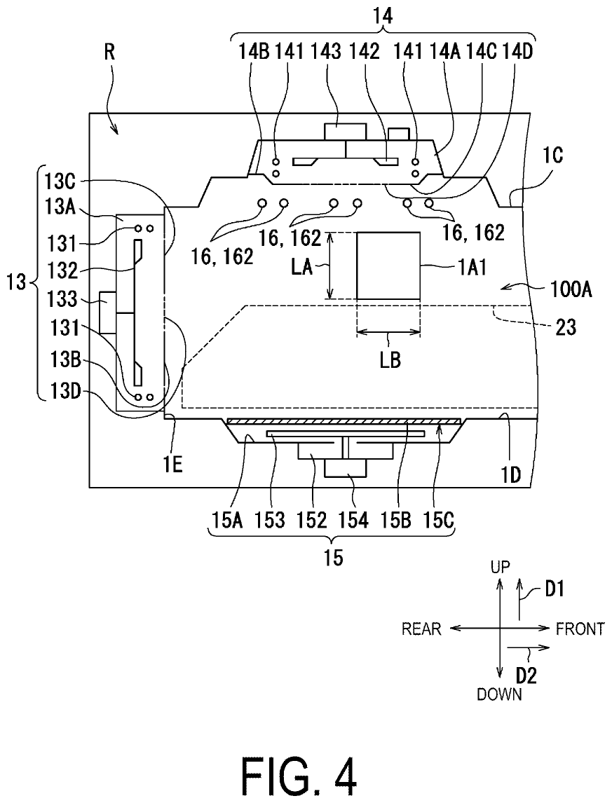

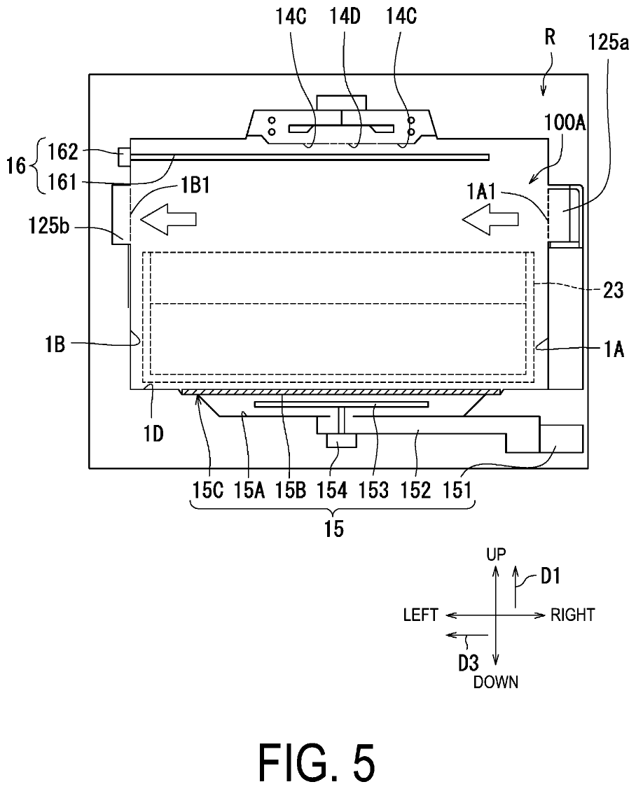

Next, the heating chamber 1 will be further described with reference to FIG. 4 and FIG. 5. FIG. 4 and FIG. 5 are schematic cross sectional views of the heating chamber 1. More specifically, FIG. 4 is a cross sectional view of the heating chamber 1 taken along a plane orthogonal to the third direction D3. FIG. 5 is a diagram illustrating a cross section of the heating chamber 1 taken along a plane orthogonal to the first direction D1.

As illustrated in FIG. 4 and FIG. 5, the pull-out type heating cooking apparatus 100 further includes a microwave supply unit 15. The microwave supply unit 15 supplies microwaves into the heating cooking chamber 100A.

The microwave supply unit 15 is positioned below the heating cooking chamber 100A. Specifically, the microwave supply unit 15 is positioned outside the heating cooking chamber 100A via the bottom wall 1D. The microwave supply unit 15 includes a partitioning member 15B, a radiation chamber 15A, a radiation port 15C, a magnetron 151, a waveguide 152, a rotary antenna 153, and an antenna motor 154. The magnetron 151 is an example of a “generation unit”. The magnetron 151 generates microwaves. The waveguide 152 propagates the microwaves generated by the magnetron 151 to the radiation chamber 15A.

The shape of the radiation port 15C is, for example, a rectangular shape. In addition, the radiation port 15C is positioned above the radiation chamber 15A and below the heating cooking chamber 100A. Specifically, the radiation port 15C is positioned at substantially a center portion of the bottom wall 1D. The rotary antenna 153 is accommodated in the radiation chamber 15A. The antenna motor 154 drives the rotary antenna 153. The rotary antenna 153 agitates microwaves and supplies the microwaves to the heating cooking chamber 100A through the radiation port 15C.

The partitioning member 15B covers the radiation port 15C. The partitioning member 15B may be required to have a shape that can cover the radiation port 15C. The partitioning member 15B is preferably a plate-like member. Further, when viewed in the up-down direction, the shape of the partitioning member 15B is, for example, a rectangular shape.

The material of the partitioning member 15B is a non-metal, and includes ceramic or glass, for example. As a result of the material of the partitioning member 15B including the ceramic or glass, the partitioning member 15B transmits microwaves. On the other hand, the material of each of the radiation chamber 15A and the waveguide 152 includes a metal.

Here, a configuration for exchanging air inside the heating cooking chamber 100A with air outside the heating cooking chamber 100A will be described. The heating cooking chamber 100A further includes an air intake hole portion 1A1, an exhaust hole portion 1B1, an air intake damper 125a, and an exhaust damper 125b. The air intake damper 125a is an example of an “opening/closing valve”.

The air intake hole portion 1A1 causes the inside and the outside of the heating cooking chamber 100A to be communicated with each other. Specifically, the air intake hole portion 1A1 is disposed at the right wall 1A. The shape of the air intake hole portion 1A1 is, for example, a rectangular shape. The size of the air intake hole portion 1A1 in the up-down direction is a first distance LA, and the size of the air intake hole portion 1A1 in the front-rear direction is a second distance LB. More specifically, the position of the lower end of the air intake hole portion 1A1 is higher than the position of the upper end of the support portion 23 of the pull-out body 2. Further, the position of the air intake hole portion 1A1 is located on the second direction D2 side of the heating cooking chamber 100A than the center of the heating cooking chamber 100A. Specifically, the air intake hole portion 1A1 is, for example, an aggregate of a plurality of punched holes. Each of the punched holes has, for example, a circular shape. The diameter of the punched hole of the air intake hole portion 1A1 is, for example, 3.4 mm in order to prevent microwaves from leaking.

The air intake damper 125a causes the air intake hole portion 1A1 to be open or closed. The air intake damper 125a is attached to the outer side of the right wall 1A. For example, when the air intake damper 125a causes the air intake hole portion 1A1 to be open, the inside and the outside of the heating cooking chamber 100A are communicated with each other. As a result, the air is guided to the air intake hole portion 1A1. On the other hand, when the air intake damper 125a causes the air intake hole portion 1A1 to be closed, the inside and the outside of the heating cooking chamber 100A are not communicated with each other. As a result, the air is not guided to the air intake hole portion 1A1.

Further, the exhaust hole portion 1B1 causes the inside and the outside of the heating cooking chamber 100A to be communicated with each other. Specifically, the exhaust hole portion 1B1 is disposed at the left wall 1B. The shape of the exhaust hole portion 1B1 is, for example, a rectangular shape. The size of the exhaust hole portion 1B1 in the up-down direction is the first distance LA, and the size of the exhaust hole portion 1B1 in the front-rear direction is the second distance LB. More specifically, the position of the lower end of the exhaust hole portion 1B1 is higher than the position of the upper end of the support portion 23 of the pull-out body 2. Further, the position of the exhaust hole portion 1B1 is located further on the second direction D2 side of the heating cooking chamber 100A than the center of the heating cooking chamber 100A. Specifically, the exhaust hole portion 1B1 is, for example, an aggregate of a plurality of punched holes. Each of the punched holes has, for example, a circular shape. The diameter of the punched hole of the exhaust hole portion 1B1 is, for example, 3.4 mm in order to prevent microwaves from leaking.

The exhaust damper 125b causes the exhaust hole portion 1B1 to be open or closed. The exhaust damper 125b is attached to the outer side of the left wall 1B. For example, when the exhaust damper 125b causes the exhaust hole portion 1B1 to be open, the inside and the outside of the heating cooking chamber 100A are communicated with each other. On the other hand, when the exhaust damper 125b causes the exhaust hole portion 1B1 to be closed, the inside and the outside of the heating cooking chamber 100A are not communicated with each other. The exhaust damper 125b may include a humidity sensor. The humidity sensor detects an amount of steam included in the air discharged from the heating cooking chamber 100A through the exhaust hole portion 1B1.

Next, a flow of the air will be described in detail. First, the air intake damper 125a causes the air intake hole portion 1A1 to be open, and the exhaust damper 125b causes the exhaust hole portion 1B1 to be open. As a result, the air is guided to the air intake hole portion 1A1. The air is blown out into the heating cooking chamber 100A through the air intake hole portion 1A1. The air blown out into the heating cooking chamber 100A from the air intake hole portion 1A1 moves along the lid portion 21 toward the third direction D3. Thereafter, the air is discharged from the exhaust hole portion 1B1 to the outside of the heating cooking chamber 100A.

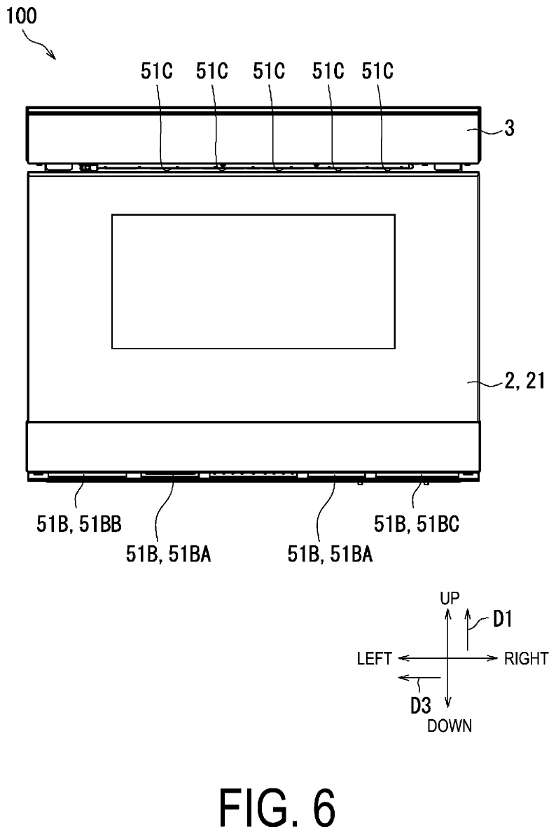

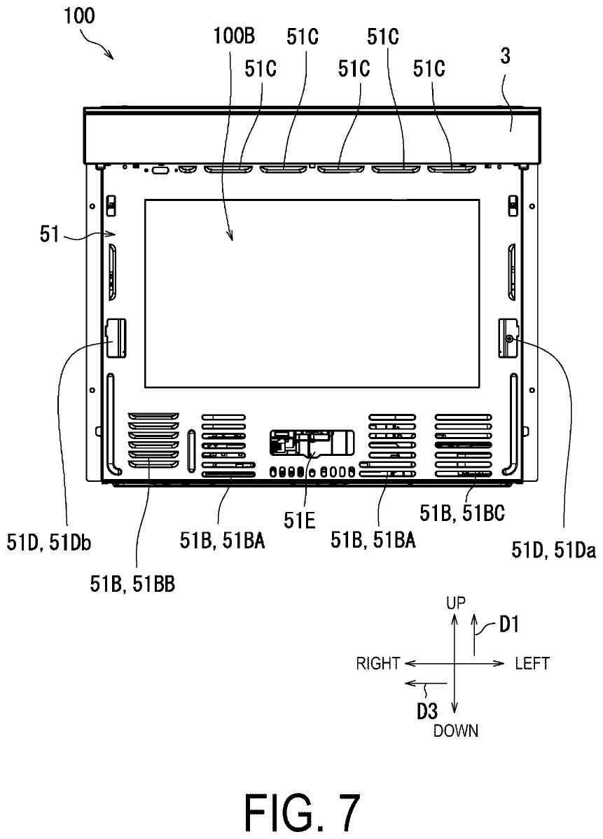

Next, the panel 51 will be further described with reference to FIG. 6 and FIG. 7. FIG. 6 and FIG. 7 are front views of the pull-out type heating cooking apparatus 100 according to the present embodiment. More specifically, FIG. 7 illustrates the pull-out type heating cooking apparatus 100 in a state where the pull-out body 2 is removed therefrom.

As illustrated in FIG. 6 and FIG. 7, the panel 51 includes a plurality of first through hole portions 51B, a plurality of second through hole portions 51C, a pair of third through hole portions 51D, and a fourth through hole portion 51E.

Each of the plurality of first through hole portions 51B, the plurality of second through hole portions 51C, the pair of third through hole portions 51D, and the fourth through hole portion 51E communicates the space R in the heating chamber 1 with the outside of the heating chamber 1.

The plurality of first through hole portions 51B are positioned in a lower side portion of the opening portion 100B. The plurality of first through hole portions 51B form four columns. Each of the four first through hole portions 51B is constituted by six or seven through holes that are arranged in a row along the up-down direction. Two columns of the four first through hole portions 51B are positioned in a right side portion of the panel 51. The other two columns of the four first through hole portions 51B are positioned in a left side portion of the panel 51.

Hereinafter, the first through hole portion 51B positioned on the leftmost side among the four columns may be referred to as an “exhaust portion 51BB”. Further, the first through hole portion 51B positioned on the rightmost side among the four columns may be referred to as an “air intake portion 51BC”. Furthermore, the first through hole portions 51B other than the columns positioned on the leftmost side and the rightmost side among the four columns may be collectively referred to as “air intake portions 51BA”.

The plurality of second through hole portions 51C are positioned in an upper side portion of the opening portion 100B. The plurality of second through hole portions 51C are disposed in a row across from the right portion to the left portion of the panel 51. Further, the positions of the lower ends of the plurality of second through hole portions 51C are higher than the position of the upper end of the lid portion 21 of the pull-out body 2.

The pair of third through hole portions 51D include a right through hole portion 51Da and a left through hole portion 51Db. The right through hole portion 51Da is positioned in a right side portion of the opening portion 100B. The left through hole portion 51Db is positioned in a left side portion of the opening portion 100B. As a result, the right slide member 241 is inserted into the right through hole portion 51Da of the panel 51. The left slide member 242 is inserted into the left through hole portion 51Db of the panel 51.

The fourth through hole portion 51E is positioned in a lower side portion of the opening portion 100B and in a substantially center portion in the right-left direction. As a result, the support member 25 is inserted into the fourth through hole portion 51E of the panel 51.

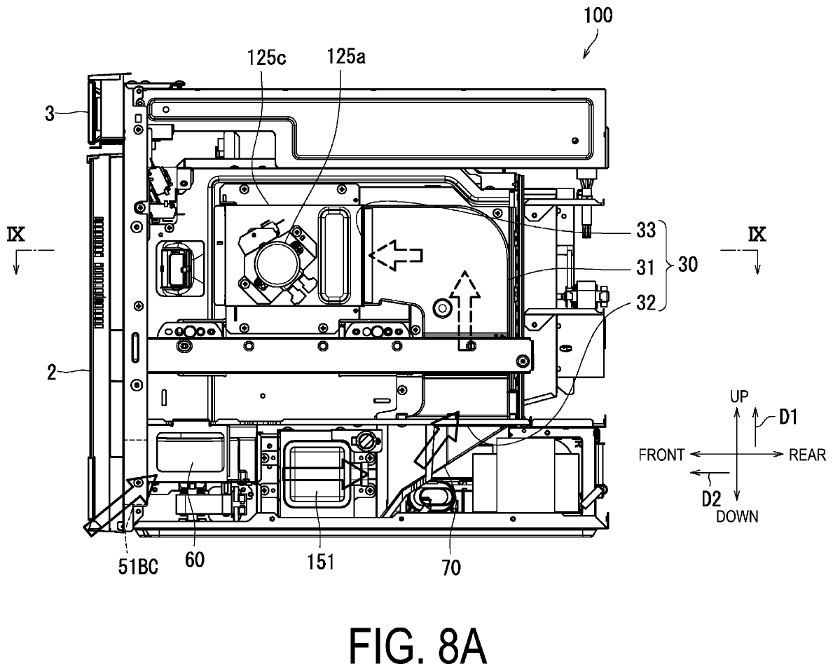

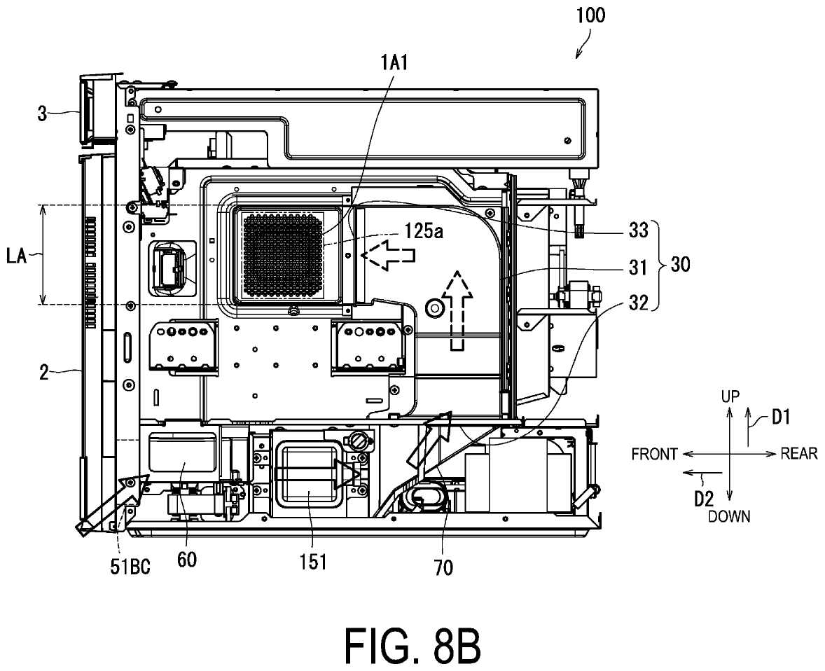

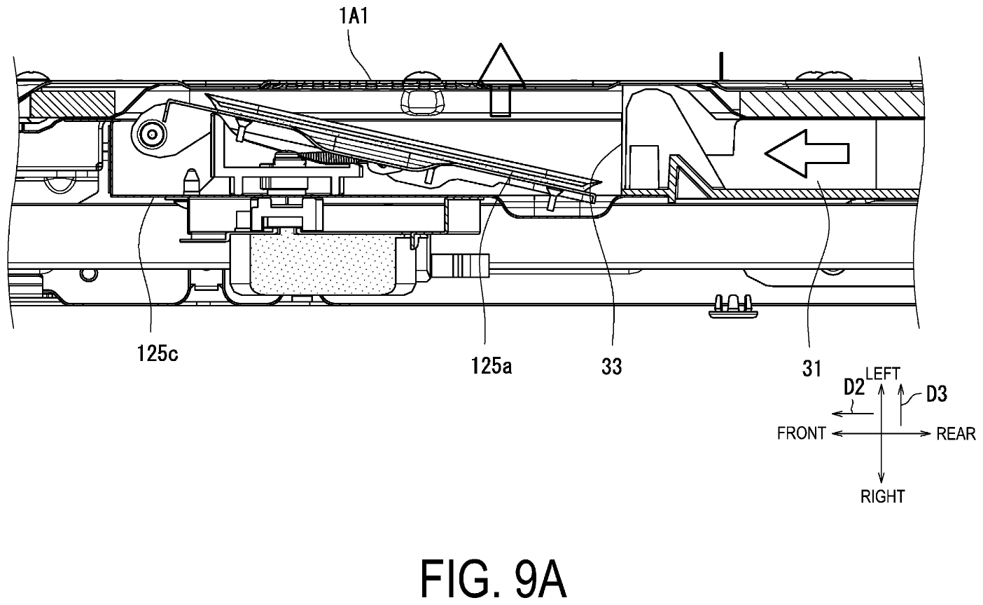

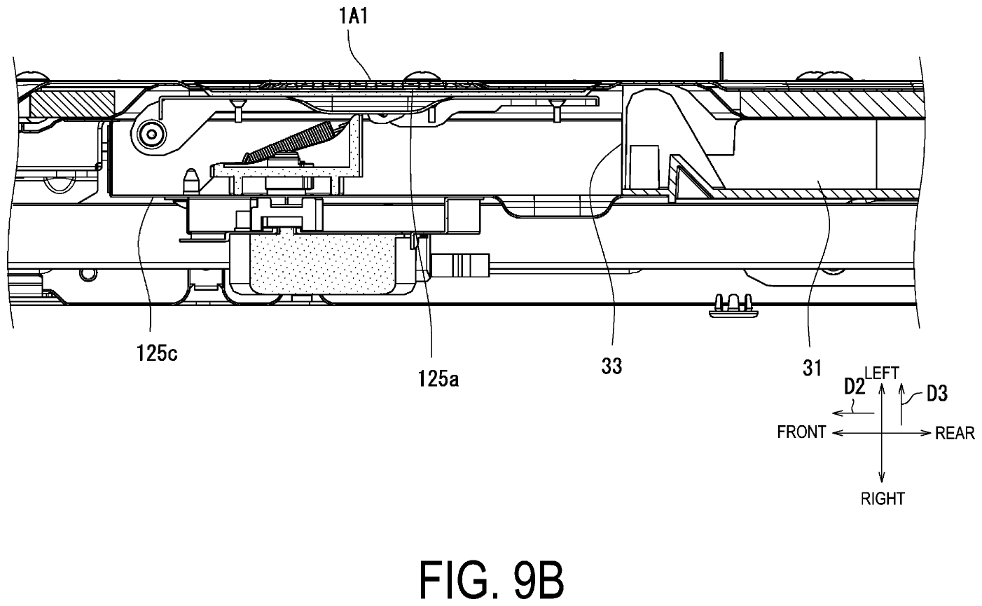

Next, a duct member 30 will be described with reference to FIG. 8A to FIG. 9B. FIG. 8A and FIG. 8B are right side surface views illustrating the pull-out type heating cooking apparatus 100 according to the present embodiment. FIG. 8A illustrates the pull-out type heating cooking apparatus 100 when the right outer wall 1G is removed therefrom, and an air intake duct 125c, to which the air intake damper 125a is attached, is attached. FIG. 8B illustrates the pull-out type heating cooking apparatus 100 when the right outer wall 1G is removed therefrom, and the air intake duct 125c, to which the air intake damper 125a is attached, is removed. FIG. 9A is an enlarged cross sectional view of the pull-out type heating cooking apparatus 100 taken along a section line IX in FIG. 8A, and illustrates a case where the air intake damper 125a causes the air intake hole portion 1A1 to be open. On the other hand, FIG. 9B is an enlarged cross sectional view of the pull-out type heating cooking apparatus 100 taken along the section line IX in FIG. 8A, and illustrates a case where the air intake damper 125a causes the air intake hole portion 1A1 to be closed.

As illustrated in FIG. 8A to FIG. 9B, the pull-out type heating cooking apparatus 100 further includes a cooling fan 60, the duct member 30, a guide member 70, and the air intake duct 125c. The cooling fan 60, the duct member 30, the guide member 70, and the air intake duct 125c are disposed outside the heating cooking chamber 100A. Specifically, the cooling fan 60, the duct member 30, the guide member 70, and the air intake duct 125c are disposed in the space R.

The duct member 30 is attached to the right wall 1A. More specifically, the duct member 30 is fixed to the right wall 1A with a screw or the like. Specifically, the duct member 30 includes a main body portion 31, a suction port 32, and a blow-out port 33.

The cooling fan 60 sends air toward the suction port 32. The cooling fan 60 is, for example, a sirocco fan. The cooling fan 60 is disposed between the air intake portion 51BC and the suction port 32. The cooling fan 60 sucks the air from the outside of the heating chamber 1 through the air intake portion 51BC, and also blows out the air toward the suction port 32. In other words, the cooling fan 60 blows out the air in the direction opposite to the second direction D2.

Further, the magnetron 151 is positioned between the cooling fan 60 and the suction port 32. In other words, the magnetron 151 is positioned further toward a side in a direction opposite to the second direction D2 than the cooling fan 60. Further, the magnetron 151 is positioned further toward the second direction D2 side than the suction port 32. The air blown out from the cooling fan 60 moves along the magnetron 151, and then reaches the suction port 32.

The guide member 70 guides the air that has moved along the magnetron 151 toward the suction port 32 of the duct member 30. Specifically, the guide member 70 changes a traveling direction of the air from the direction opposite to the second direction D2, to the first direction D1.

The air is sucked into the main body portion 31 through the suction port 32. The shape of the suction port 32 is, for example, a rectangular shape. The suction port 32 opens in the direction opposite to the first direction D1. Specifically, the air that has been guided from the guide member 70 is sucked into the main body portion 31. More specifically, the air traveling in the first direction D1 is sucked into the main body portion 31.

The main body portion 31 guides the air so that the air travels from the first direction D1 to the second direction D2. Specifically, the main body portion 31 changes the traveling direction of the air by 90°.

The air is blown out in the second direction D2 at the blow-out port 33. The shape of the blow-out port 33 is, for example, a rectangular shape. The size of the blow-out port 33 in the up-down direction is the first distance LA. The blow-out port 33 opens toward the direction opposite to the second direction D2. The blow-out port 33 is disposed further toward a side in a direction opposite to the second direction D2 than the air intake hole portion 1A1. As a result, the air is blown out toward the air intake hole portion 1A1 at the blow-out port 33.

The air intake duct 125c covers the air intake hole portion 1A1, the blow-out port 33, and the air intake damper 125a. More specifically, the air intake damper 125a includes a plate-like member disposed in the air intake duct 125c. Thus, when the air intake damper 125a causes the air intake hole portion 1A1 to be closed, the plate-like member of the air intake damper 125a covers the air intake hole portion 1A1, so the air is not guided to the air intake hole portion 1A1. As a result, the air stays in the air intake duct 125c. On the other hand, when the air intake damper 125a causes the air intake hole portion 1A1 to be open, the plate-like member of the air intake damper 125a is inclined in the third direction D3 toward the second direction D2, and the air is guided to the air intake hole portion 1A1.

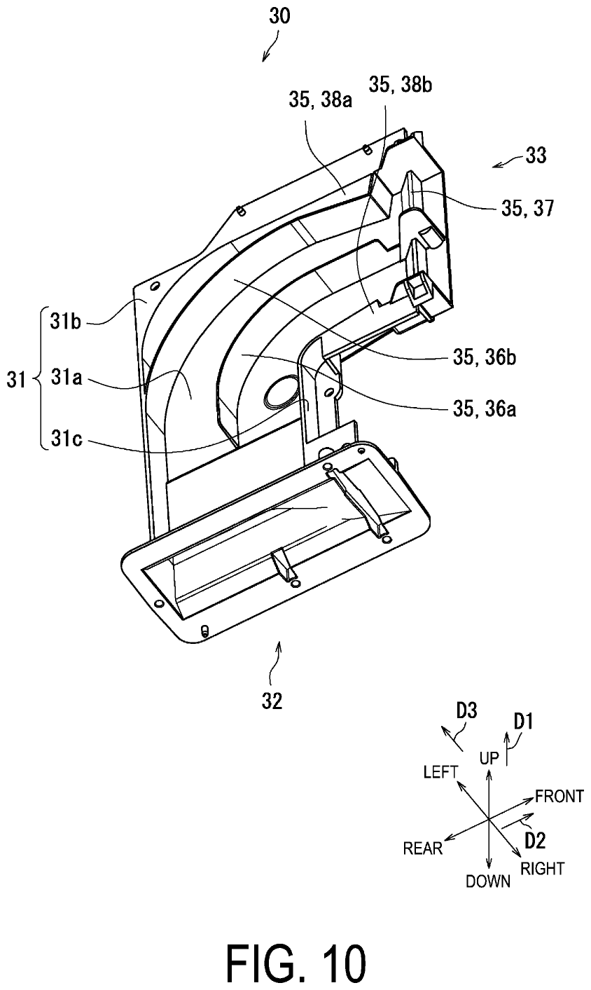

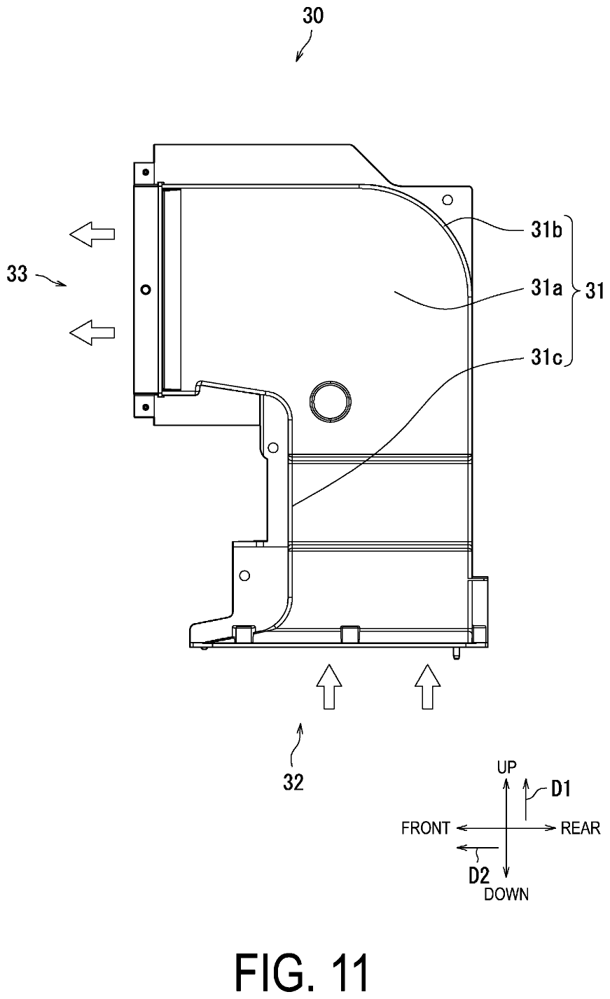

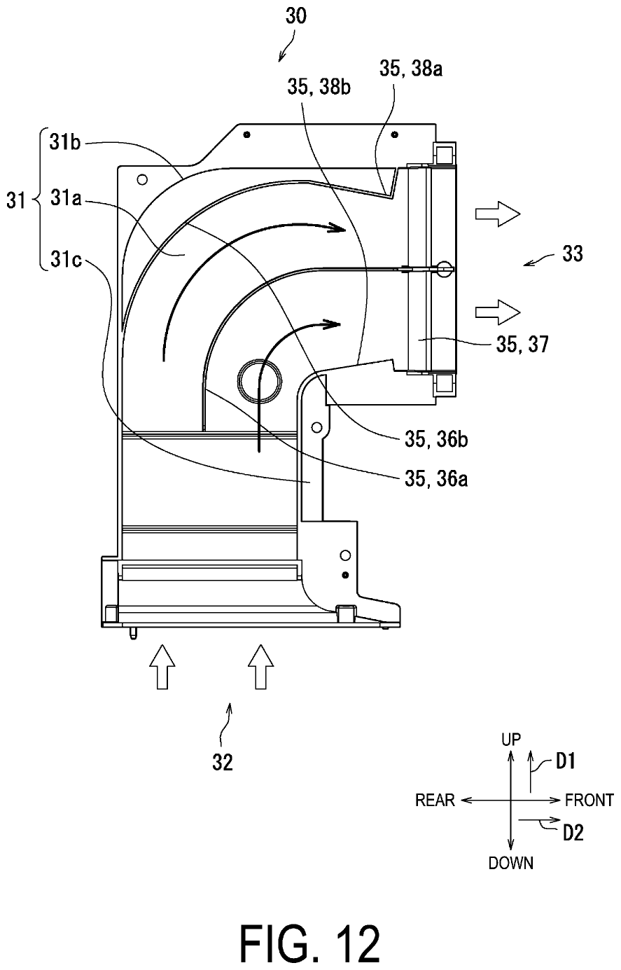

Next, the duct member 30 will be described in detail with reference to FIG. 8 to FIG. 12. FIG. 10 is a perspective view illustrating the duct member 30. FIG. 11 is a right side surface view illustrating the duct member 30. FIG. 12 is a left side view illustrating the duct member 30. As illustrated in FIG. 10 to FIG. 12, the duct member 30 further includes a rectifying portion 35 in addition to the main body portion 31, the suction port 32, and the blow-out port 33. In the present embodiment, the duct member 30 further includes a plurality of the rectifying portions 35.

The rectifying portion 35 determines at least one of a blow-out direction and an airflow distribution of the air at the blow-out port 33, and guides the air to the air intake hole portion 1A1. For example, the rectifying portion 35 adjusts the blow-out direction of the air so as to suppress the blow-out direction of the air at the blow-out port 33 from becoming a direction different from the second direction D2 in a side view. More specifically, the air blown out from the blow-out port 33 is suppressed from flowing to a side in a direction above the air intake hole portion 1A1. Further, the air blown out from the blow-out port 33 is suppressed from flowing to a side in a direction below the air intake hole portion 1A1.

Further, the rectifying portion 35 adjusts the airflow distribution of the air so as to suppress an increase in the difference between the airflow at the blow-out port 33 on the first direction D1 side (outer peripheral side) and the airflow at the blow-out port 33 on the side in the direction opposite to the first direction D1 (inner peripheral side). More specifically, the airflow at the blow-out port 33 on the first direction D1 side (outer peripheral side) is suppressed from becoming excessively greater than the airflow at the blow-out port 33 on the side in the direction opposite to the first direction D1 (inner peripheral side).

Furthermore, the rectifying portion 35 adjusts the blow-out direction of the air so that the blow-out direction of the air at the blow-out port 33 is a direction toward the air intake hole portion 1A1 in a plan view.

As described above, with reference to FIG. 1 to FIG. 12, the rectifying portion 35 determines at least one of the blow-out direction and the airflow distribution of the air at the blow-out port 33, and guides the air to the air intake hole portion 1A1. As a result, the air that has cooled components such as the magnetron 151 can be utilized. Specifically, the air that has cooled the components can be efficiently introduced into the heating cooking chamber 100A. Further, the air blown out into the heating cooking chamber 100A from the air intake hole portion 1A1 can efficiently move in the heating cooking chamber 100A. As a result, the humidity sensor of the exhaust damper 125b can accurately detect the amount of steam included in the air discharged from the heating cooking chamber 100A.

Further, the cooling fan 60 sends the air toward the suction port 32. As a result, the air can be more efficiently introduced into the heating cooking chamber 100A.

Furthermore, the magnetron 151 is positioned between the cooling fan 60 and the suction port 32. As a result, the air that has cooled the magnetron 151 can be efficiently introduced into the heating cooking chamber 100A.

More specifically, the main body portion 31 includes a main body wall portion 31a, a first wall portion 31b, and a second wall portion 31c. The main body wall portion 31a is disposed further toward the side in a direction opposite to the third direction D3 than the right wall 1A. The main body wall portion 31a is a plate-like member. The main body wall portion 31a faces the right wall 1A.

The first wall portion 31b extends in the third direction D3 from the main body wall portion 31a. The first wall portion 31b extends up to the right wall 1A from the main body wall portion 31a. The shape of the first wall portion 31b is a substantially L-shape.

The second wall portion 31c extends in the third direction D3 from the main body wall portion 31a. The second wall portion 31c extends up to the right wall 1A from the main body wall portion 31a. The second wall portion 31c faces the first wall portion 31b. The shape of the second wall portion 31c is substantially L-shaped.

The rectifying portion 35 may include a first guide plate 36a. The first guide plate 36a extends in the third direction D3 from the main body wall portion 31a. The first guide plate 36a is disposed between the first wall portion 31b and the second wall portion 31c. The first guide plate 36a includes an arc portion that guides the air. Specifically, the first guide plate 36a is a plate-like member. The first guide plate 36a is disposed substantially at the center between the first wall portion 31b and the second wall portion 31c.

As a result, the first guide plate 36a can smoothly change the traveling direction of the air from the first direction D1 to the second direction D2. Thus, the airflow at the blow-out port 33 on the first direction D1 side (outer peripheral side) can be suppressed from becoming excessively greater than the airflow at the blow-out port 33 on the side in the direction opposite to the first direction D1 (inner peripheral side).

Further, the rectifying portion 35 may include a second guide plate 36b. The second guide plate 36b extends in the third direction D3 from the main body wall portion 31a. The second guide plate 36b is disposed between the first wall portion 31b and the second wall portion 31c. The second guide plate 36b includes an arc portion that guides the air. Specifically, the second guide plate 36b is a plate-like member. The second guide plate 36b is disposed closer to the first wall portion 31b than the first guide plate 36a.

As a result, the second guide plate 36b can smoothly change the traveling direction of the air from the first direction D1 to the second direction D2. Thus, the air blown out from the blow-out port 33 can be suppressed from flowing to the side in the direction above the air intake hole portion 1A1. As a result, the air can be efficiently introduced into the heating cooking chamber 100A.

Further, the rectifying portion 35 may include an inclined portion 37 that is inclined in the third direction D3 toward the second direction D2. The inclined portion 37 is disposed on the blow-out port 33 side of the main body wall portion 31a. Specifically, the inclined portion 37 is a triangular prism body.

As a result, the inclined portion 37 can adjust the blow-out direction of the air so that the blow-out direction of the air at the blow-out port 33 is a direction toward the air intake hole portion 1A1 in a plan view. Thus, the air can be efficiently introduced into the heating cooking chamber 100A.

Further, the rectifying portion 35 may include a first narrowing portion 38a that extends in the third direction D3 from the main body wall portion 31a. The first narrowing portion 38a reduces the size of the blow-out port 33 toward the second direction D2. Specifically, the first narrowing portion 38a is a plate-like member. The first narrowing portion 38a is disposed closer to the blow-out port 33 side than the second guide plate 36b.

As a result, the first narrowing portion 38a can increase the velocity of the air blown out from the blow-out port 33. Thus, the first narrowing portion 38a can adjust the blow-out direction of the air so that the blow-out direction of the air at the blow-out port 33 is the second direction D2 in a side view. Furthermore, the air blown out from the blow-out port 33 can be suppressed from flowing to the side in the direction above the air intake hole portion 1A1. As a result, the air can be efficiently introduced into the heating cooking chamber 100A.

Further, the rectifying portion 35 may include a second narrowing portion 38a that extends in the third direction D3 from the main body wall portion 31a. The second narrowing portion 38b reduces the size of the blow-out port 33 toward the second direction D2. Specifically, the second narrowing portion 38b is a triangular prism body. The second narrowing portion 38b is disposed on the blow-out port 33 side of the second wall portion 31c.

As a result, the second narrowing portion 38b can increase the velocity of the air blown out from the blow-out port 33. Thus, the second narrowing portion 38b can adjust the blow-out direction of the air so that the blow-out direction of the air at the blow-out port 33 is the second direction D2 in a side view. As a result, the air can be efficiently introduced into the heating cooking chamber 100A.

The duct member 30 is attached to the right wall 1A. As a result, air sending units can be disposed at the top wall 1C and the back wall 1E. Here, once again as illustrated in FIG. 4 and FIG. 5, the pull-out type heating cooking apparatus 100 further includes a first air sending unit 13, a second air sending unit 14, and a grill unit 16.

First, the first air sending unit 13 will be described. The first air sending unit 13 supplies hot air into the heating cooking chamber 100A. Specifically, the first air sending unit 13 includes a suction hole portion 13D, a plurality of blow-out hole portions 13C, and a partitioning member 13B. The first air sending unit 13 is disposed at the back wall 1E. More specifically, the first air sending unit 13 is positioned behind the heating cooking chamber 100A via the back wall 1E. The suction hole portion 13D is positioned behind the placing space 120. Each of the plurality of blow-out hole portions 13C is positioned behind the placing space 120.

The first air sending unit 13 sucks the hot air in the heating cooking chamber 100A through the suction hole portion 13D, and blows the hot air into the heating cooking chamber 100A through the plurality of blow-out hole portions 13C. More specifically, the first air sending unit 13 sucks the hot air from a center portion in the heating cooking chamber 100A, and blows out the hot air to a peripheral edge portion in the heating cooking chamber 100A. As a result, the entire space in the heating cooking chamber 100A can be heated by driving the first air sending unit 13.

More specifically, the first air sending unit 13 further includes an air sending chamber 13A, a heater 131, a centrifugal fan 132, and a drive unit 133. The air sending chamber 13A is, for example, a box-like member. The centrifugal fan 132 includes a plurality of blades.

The heater 131 and the centrifugal fan 132 are accommodated in the air sending chamber 13A. The heater 131 heats the air inside the air sending chamber 13A to generate hot air. Specifically, the shape of the heater 131 is a circular ring shape when viewed from the front side to the rear side. Further, the heater 131 is disposed along the outer circumference of the centrifugal fan 132.

The drive unit 133 is positioned outside the air sending chamber 13A. The drive unit 133 energizes the heater 131 and also drives the centrifugal fan 132. The drive unit 133 includes, for example, a motor and an energization unit.

The partition member 13B is positioned behind the placing space 120. Specifically, the partitioning member 13B is positioned between the air sending chamber 13A and the heating cooking chamber 100A. The partitioning member 13B is, for example, a plate-like member made of a metal. The shape of the partitioning member 13B is, for example, a rectangular shape when viewed from the front side to the rear side. The partitioning member 13B is disposed over a substantially entire surface of the back wall 1E. The suction hole portion 13D and the plurality of blow-out hole portions 13C are disposed at the partitioning member 13B. Thus, the suction hole portion 13D and the blow-out hole portions 13C can be easily disposed behind the placing space 120.

Specifically, the suction hole portion 13D is, for example, an aggregate of a plurality of punched holes. Similarly, the blow-out hole portion 13C is also, for example, an aggregate of a plurality of punched holes. Each of the punched holes has, for example, a circular shape. The diameter of each of the punched holes of the suction hole portion 13D and the blow-out hole portions 13C is, for example, 3.4 mm to prevent microwaves from leaking.

More specifically, the blow-out hole portions 13C are disposed along the outer circumference of the partitioning member 13B. Specifically, the suction hole portion 13D is positioned at a center portion of the partitioning member 13B. Further, the blow-out hole portions 13C are positioned at a peripheral edge portion along the edge of the back wall 1E.

Next, the second air sending unit 14 will be described. The second air sending unit 14 supplies hot air into the heating cooking chamber 100A. Specifically, the second air sending unit 14 includes a suction hole portion 14D, a plurality of blow-out hole portions 14C, and a partitioning member 14B. The second air sending unit 14 is disposed at the top wall 1C. More specifically, the second air sending unit 14 is positioned behind the heating cooking chamber 100A via the top wall 1C. The suction hole portion 14D is positioned above the placing space 120. Each of the plurality of blow-out hole portions 14C is positioned above the placing space 120.

The second air sending unit 14 sucks the hot air in the heating cooking chamber 100A through the suction hole portion 14D, and blows the hot air into the heating cooking chamber 100A through the plurality of blow-out hole portions 14C. More specifically, the second air sending unit 14 sucks the hot air from the center portion in the heating cooking chamber 100A, and blows out the hot air to the peripheral edge portion in the heating cooking chamber 100A. As a result, the entire space in the heating cooking chamber 100A can be heated by driving the second air sending unit 14.

More specifically, the second air sending unit 14 further includes an air sending chamber 14A, a heater 141, a centrifugal fan 142, and a drive unit 143. The air sending chamber 14A is, for example, a box-like member. The centrifugal fan 142 includes a plurality of blades.

The heater 141 and the centrifugal fan 142 are accommodated in the air sending chamber 14A. The heater 141 heats air inside the air sending chamber 14A to generate hot air. Specifically, the shape of the heater 141 is a circular ring shape when viewed from the upper side to the lower side. Further, the heater 141 is disposed along the outer circumference of the centrifugal fan 142.

The drive unit 143 is positioned outside the air sending chamber 14A. The drive unit 143 energizes the heater 141, and also drives the centrifugal fan 142. The drive unit 143 includes, for example, a motor and an energization unit.

The partition member 14B is positioned above the placing space 120. Specifically, the partitioning member 14B is positioned between the air sending chamber 14A and the heating cooking chamber 100A. The partitioning member 14B is, for example, a plate-like member made of a metal. The shape of the partitioning member 14B is, for example, a rectangular shape when viewed from the upper side to the lower side. The partitioning member 14B is disposed over a substantially entire surface of the top wall 1C. The suction hole portion 14D and the plurality of blow-out hole portions 14C are disposed at the partitioning member 14B. Thus, the suction hole portion 14D and the blow-out hole portions 14C can be easily disposed above the placing space 120.

More specifically, the suction hole portion 14D is, for example, an aggregate of a plurality of punched holes. Similarly, the blow-out hole portion 14C is also, for example, an aggregate of a plurality of punched holes. Each of the punched holes has, for example, a circular shape. The diameter of each of the punched holes of the suction hole portion 14D and the blow-out hole portions 14C is, for example, 3.4 mm to prevent microwaves from leaking.

More specifically, the blow-out hole portions 14C are disposed along the outer circumference of the partitioning member 14B. Specifically, the suction hole portion 14D is positioned at a center portion of the partitioning member 14B. Further, the blow-out hole portions 14C are positioned at a peripheral edge portion along the edge of the top wall 1C.

Next, a grill unit 16 will be described. Specifically, the grill unit 16 includes a heater 161 and an energization unit 162. The heater 161 is positioned in the heating cooking chamber 100A and heats the object H to be heated. Specifically, the heater 161 is positioned at an upper portion in the heating cooking chamber 100A. The heater 161 is substantially U-shaped when viewed in the vertical direction. In the present embodiment, three of the grill units 16 are disposed. The heater 161 is, for example, a sheathed heater. The energization unit 162 is positioned outside the heating cooking chamber 100A. The energization unit 162 energizes the heater 161. The energized heater 161 generates heat.

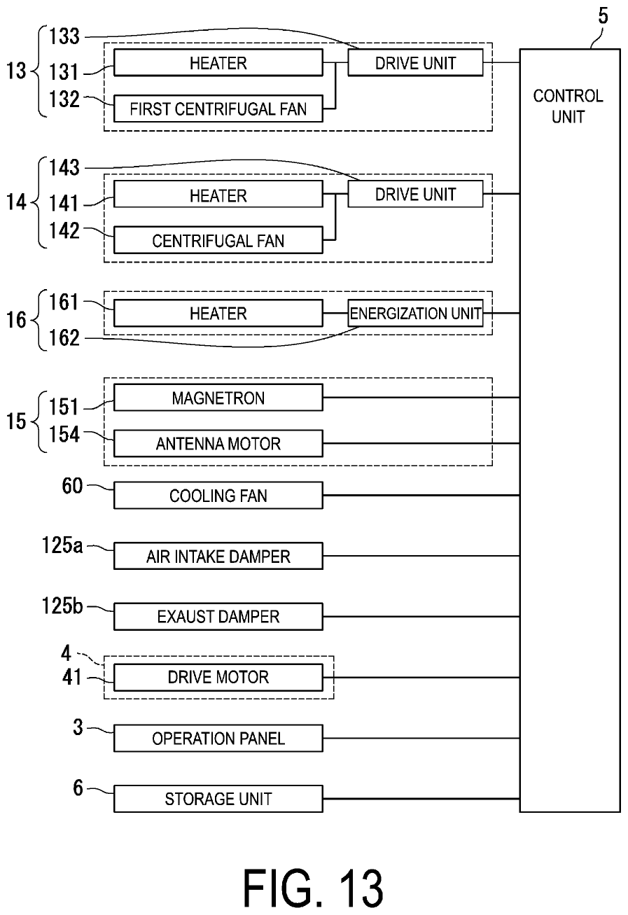

Next, a configuration of the pull-out type heating cooking apparatus 100 will be described in detail with reference to FIG. 13. FIG. 13 is a block diagram illustrating the configuration of the pull-out type heating cooking apparatus 100. In the present embodiment, the pull-out type heating cooking apparatus 100 has a “microwave heating mode,” a “hot air circulation heating mode,” and a “grill heating mode” as heating cooking modes. The “microwave heating mode” is mainly a mode in which the object H to be heated is heated and cooked by radiating microwaves into the heating cooking chamber 100A. The “grill heating mode” is mainly a mode in which the object H to be heated is heated and cooked by conducting the heat generated by the heater 161 to the object H to be heated. The “hot air circulation heating mode” is mainly a mode in which the object H to be heated is heated and cooked by circulating hot air in the heating cooking chamber 100A to make the temperature in the heating cooking chamber 100A uniform.

By executing the control program stored in the storage unit 6, the control unit 5 controls the magnetron 151, the antenna motor 154, the energization unit 162, the drive motor 41, the operation panel 3, the cooling fan 60, the air intake damper 125a, the exhaust damper 125b, the drive unit 133, the drive unit 143, and the storage unit 6.

More specifically, the control unit 5 controls driving of the microwave supply unit driving of the first air sending unit 13, driving of the second air sending unit 14, and driving of the grill unit 16. For example, when the “microwave heating mode” is selected, the control unit 5 drives the cooling fan 60, the magnetron 151, and the antenna motor 154 in a state where the air intake damper 125a and the exhaust damper 125b are open. Note that when the “hot air circulation heating mode” or the “grill heating mode” is selected on its own or combined with another mode, the control unit 5 drives the magnetron 151, the antenna motor 154, the energization unit 162, the drive motor 41, the cooling fan 60, the drive unit 133, and the drive unit 143 in a state where the air intake damper 125a and the exhaust damper 125b are closed.

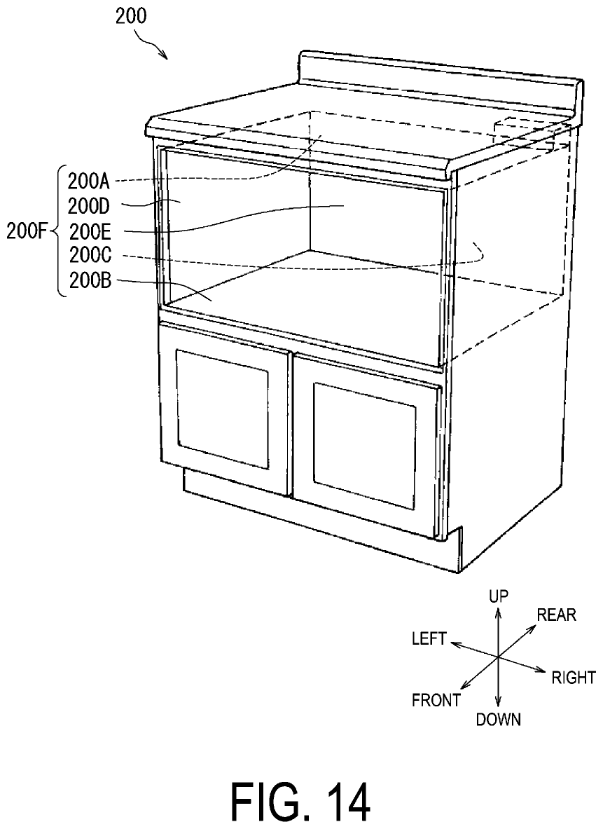

Next, a cabinet 200 to which the pull-out type heating cooking apparatus 100 is attached will be described with reference to FIG. 14. FIG. 14 is a perspective view illustrating the cabinet 200 to which the pull-out type heating cooking apparatus 100 is attached.

As illustrated in FIG. 14, the pull-out type heating cooking apparatus 100 is attached to and installed in the cabinet 200. The cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space into which the pull-out type heating cooking apparatus 100 is fitted.

The embodiment of the present invention has been described above with reference to the accompanying drawings. However, the present invention is not limited to the embodiment described above, and the present invention can be implemented in various modes without departing from the gist thereof. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. Further, the material, shape, dimensions, and the like of each of the constituent elements illustrated in the embodiment described above are merely examples and are not particularly limited, and various modifications can be made within the scope not substantially departing from the effects of the present invention.

As described with reference to FIG. 1 to FIG. 14, the air intake hole portion 1A1 is the aggregate of the plurality of punched holes, but the present invention is not limited thereto. For example, the air intake hole portion 1A1 may be one opening portion, may be a plurality of slit holes, or may be a net-like portion.

### INDUSTRIAL APPLICABILITY

The present invention provides a heating cooking apparatus, and the provided heating cooking apparatus has industrial applicability.

### REFERENCE SIGNS LIST

1 Heating chamber
1A1 Air intake hole portion
30 Duct member
31 Main body portion
32 Suction port
33 Blow-out port
35 Rectifying portion
100 Pull-out type heating cooking apparatus
D1 First direction
D2 Second direction

1. A heating cooking apparatus comprising:
a heating cooking chamber configured to accommodate an object to be heated; and
a duct member disposed outside the heating cooking chamber,
wherein the heating cooking chamber includes an air intake hole portion configured to cause an inside and an outside of the heating cooking chamber to be communicated with each other, and
the duct member includes
a main body portion configured to guide air in a manner that the air travels from a first direction to a second direction intersecting the first direction,
a suction port through which the air is sucked into the main body portion,
a blow-out port from which the air is blown out toward the air intake hole portion, and
a rectifying portion configured to determine at least one of a blow-out direction or an airflow distribution of the air at the blow-out port, and to guide the air to the air intake hole portion.

2. The heating cooking apparatus according to claim 1,
wherein the heating cooking chamber further includes a plurality of side walls,
the air intake hole portion is disposed at a predetermined side wall of the plurality of side walls, and
the duct member is attached to the predetermined side wall.

3. The heating cooking apparatus according to claim 2,
wherein the main body portion includes
a main body wall portion disposed further toward a side in a direction opposite to a third direction than the predetermined side wall,
a first wall portion extending in the third direction from the main body wall portion, and
a second wall portion extending in the third direction from the main body wall portion, and facing the first wall portion,
the rectifying portion includes a guide plate extending in the third direction from the main body wall portion and disposed between the first wall portion and the second wall portion,
the guide plate includes an arc portion configured to guide the air, and
the third direction intersects each of the first direction and the second direction.

4. The heating cooking apparatus according to claim 2,
wherein the main body portion includes a main body wall portion disposed further toward a side in a direction opposite to a third direction than the predetermined wall portion,
the rectifying portion includes an inclined portion inclined in the third direction toward the second direction,
the inclined portion is disposed on the blow-out port side of the main body wall portion, and
the third direction intersects each of the first direction and the second direction.

5. The heating cooking apparatus according to claim 2,
wherein the main body portion includes a main body wall portion disposed further toward a side in a direction opposite to a third direction than the predetermined wall portion,
the rectifying portion includes a narrowing portion extending in the third direction from the main body wall portion,
the narrowing portion reduces a size of the blow-out port toward the second direction, and
the third direction intersects each of the first direction and the second direction.

6. The heating cooking apparatus according to claim 1,
wherein the heating cooking chamber further includes an opening/closing valve configured to open and close the air intake hole portion.

7. The heating cooking apparatus according to claim 1, further comprising:
a fan configured to send air toward the suction port.

8. The heating cooking apparatus according to claim 7, further comprising:
a microwave supply unit positioned below the heating cooking chamber and configured to supply microwaves to the heating cooking chamber,
wherein the microwave supply unit includes a generation unit configured to generate the microwaves, and
the generation unit is positioned between the suction port and the fan.
